(19) United States
(12) Patent Application Publication
(10) Pub. No.: US 2026/0040320 A1
(43) Pub. Date: Feb. 5, 2026

(54) METHODS AND APPARATUSES FOR SUPPORTING NETWORK COMMUNICATION

(71) Applicant: Huawei Technologies Co., Ltd., Shenzhen (CN)

(72) Inventors: Hao Tang, Ottawa (CA); Liqing Zhang, Ottawa (CA); Jianglei Ma, Ottawa (CA)

(21) Appl. No.: 19/355,571

(22) Filed: Oct. 10, 2025

Related U.S. Application Data
(63) Continuation of application No. PCT/CN2023/105200, filed on Jun. 30, 2023.
(60) Provisional application No. 63/458,470, filed on Apr. 11, 2023.

(51) Int. Cl. H04W 72/23; H04W 64/00; H04W 74/0833

(52) U.S. Cl. CPC H04W 72/23; H04W 64/00; H04W 74/0833

(57) ABSTRACT

A terminal side device may detect a SSB using a non-reference timing point frame timing. Based on information in the SSB, the terminal side device may be able to determine timing reference point information. The terminal side device may then be able to use the reference timing point frame timing for other signaling.

### CROSS-REFERENCE TO RELATED APPLICATIONS

This application is a continuation of International Application No. PCT/CN2023/105200, filed on Jun. 30, 2023, which claims priority to U.S. Patent Application No. 63/458,470, filed on Apr. 11, 2023, both of which are hereby incorporated by reference in their entireties.

### TECHNICAL FIELD

The present disclosure relates generally to wireless communications, and in particular to methods and apparatuses for supporting network communication using timing alignment.

### BACKGROUND

There are known methods of establishing frame timing alignment that might be suitable for serving applications in current wireless communication networks, such as long-term evolution (LTE) or fifth generation (5G) new radio (NR). However, it may be challenging to establish a standardized frame timing alignment process for use among diverse frame structures such that the frame timing alignment is suitable for serving some of the applications that are being considered for future wireless communication networks, such as sixth generation (6G) wireless communication network.

One challenge that might be encountered in future wireless communication networks is related to integrated communication and sensing. In integrated communication and sensing, a first bandwidth part (BWP) may use a first waveform type, such as a single carrier orthogonal frequency division multiple access (OFDM) waveform, for sensing, and a second BWP may use a second waveform type, such as a multi-carrier OFDM waveform, for communication. For example, in the first BWP, a single subcarrier may be used for sensing, and the symbol length may depend on the frequency of the single subcarrier, e.g., T=1/f. In the second BWP, the symbol length may depend on the subcarrier spacing. Since the symbol length may be determined based on different factors in each BWP, existing methods of establishing frame timing alignment may not be suitable for integrated communication and sensing.

Another challenge that might be encountered in future wireless communication networks is related to measurement of a time gap duration, for example that may be used during switching between time-divisional duplex (TDD) downlink (DL) and uplink (UL) communications. In current wireless communication networks, a gap between actions may be indicated in terms of symbols, i.e., the granularity is on a per symbol basis. In other words, in current wireless communication networks, the gap between actions may be one or multiple symbols. Alternatively, in future wireless communication networks (e.g., 6G), a gap between actions may be less than one symbol to reduce air interface overhead. As such, a transmitter and a receiver may communicate with each other after a variable time gap duration.

Therefore, there may be restrictions when an effort is made to establish that the two types of signals are always timing aligned based on their respective frames, subframes, slots, and/or symbols.

### SUMMARY

Aspects of the present disclosure provide methods and apparatuses to overcome the shortcomings described above, as well as specific methods and apparatuses for supporting network communication using configuration information for timing alignment to achieve improved timing alignment.

Aspects of the present disclosure enable timing reference point alignment for downlink (DL) and uplink (UL) by compensating for propagation delay. In some embodiments, the propagation delay may be compensated by the network or a network-side device, such as a base station. In some embodiments, the propagation delay may be compensated by terminal side device, such as a user equipment (UE).

Aspects of the present disclosure enable using one or more types of frame timing as part of an initial access method. An example of a first type of frame timing is a timing reference point frame timing. In some embodiments, the terminal side device may use timing reference point frame timing to detect a synchronization signal block (SSB). Based on information in the SSB, the terminal side device may determine whether timing reference point information has been updated. The terminal side device then continues to use the reference timing point frame timing for other signaling. An example of a second type of frame timing is a frame timing that does not rely on a timing reference point. In some embodiments, the terminal side device may detect a SSB using a non-reference timing point frame timing. Based on information in the SSB, the terminal side device may be able to determine timing reference point information. The terminal side device may then be able to use the reference timing point frame timing for other signaling after the timing reference point information has been determined by the non-reference timing point frame timing. Using the non-reference timing point time frame initially may aid in detecting the SSB and determining a timing reference point indication, without being aware of an initial timing reference point.

According to an aspect of the disclosure there is provided a method for initial access involving: receiving at least one synchronization signal block (SSB) in a frame; detecting the at least one SSB; determining a location of a physical resource including a physical downlink control channel (PDCCH) carrying system information block (SIB) control information; and determining a timing reference point from a SIB that is locatable using the SIB control information.

In some embodiments, frame timing is determined based on the detected SSB and the frame timing is used for control resource set 0 (CORESET0) time location determination and system information block 1 (SIB1) detection.

In some embodiments, the method further involving determining a second frame timing based on the timing reference point, wherein the second frame timing is used for physical channel transmission.

In some embodiments, the timing reference point is expressed in the form of at least one of: a) a reference system frame number (SFN) plus an offset to the timing reference point; b) an offset to the timing reference point, the offset with reference to a reference system frame that is pre-defined to be a SFN where SIB that includes the timing reference point is located; or c) an absolute timing value.

In some embodiments, the method further involving receiving random access channel (RACH) occasion (RO) configuration information indicating locations available for transmission of a RACH preamble to a network side device.

In some embodiments, the method further involving determining a RO for transmitting the RACH preamble based on the RO configuration information wherein the determining the RO is performed based on: a SFN or a slot index or a symbol index with reference to frame timing based on the received SSB; or a SFN or a slot index or a symbol index with reference to frame timing based on the timing reference point.

In some embodiments, transmitting the RACH preamble involves transmitting the RACH preamble in a message 1 (MSG1) transmission on the determined RO.

In some embodiments, the method further involving receiving a random access response (RAR) in a message 2 (MSG2) transmission.

In some embodiments, the method further involving decoding downlink control information (DCI) including the RAR using a random access radio network temporary identifier (RA-RNTI) based on at least one of a slot index or a symbol index associated with the transmitted RACH preamble.

In some embodiments, the RA-RNTI based on at least one of the slot index or symbol index of the RACH preamble transmission is one of: a slot index or symbol index with reference to the frame timing based on the received SSB; or a slot index or symbol index with reference to the frame timing based on the timing reference point.

In some embodiments, the method further involving sending a message 3 (MSG3) transmission based on: a SFN or slot index or symbol index with reference to the frame timing based on the received SSB; or a SFN or slot index or symbol index with reference to the frame timing based on the timing reference point.

In some embodiments, the method further involving receiving a message 4 (MSG4) transmission based on: a SFN or slot index or symbol index with reference to the frame timing based on the received SSB; or a SFN or slot index or symbol index with reference to the frame timing based on the timing reference point.

In some embodiments, the method further involving receiving information indicative of a SFN of a starting frame in a frame structure, wherein a starting boundary of the starting frame is aligned with the timing reference point.

In some embodiments, a SFN of a starting frame in frame structure is determined according to a predetermined rule, wherein a starting boundary of the starting frame is aligned with the timing reference point.

In some embodiments, the predetermined rule: indicates that the SFN of the starting frame is to be updated based on the timing reference point; indicates that the starting frame is SFN0 in a frame structure updated based on the timing reference point; or indicates that the SFN of the starting frame is determined based on a starting frame of a frame structure having a different timing reference point, wherein the starting boundary of the frame structure is aligned with the different timing reference point.

In some embodiments, when at least one SSB is not successfully received during a predefined duration, the detecting of the at least one SSB is performed for additional SSB.

According to an aspect of the disclosure there is provided an apparatus including: one or more processor configured to: receive at least one SSB in a frame; detect the at least one SSB; determine a location of a physical resource including a PDCCH carrying SIB control information; and determine a timing reference point from a SIB that is locatable using the SIB control information.

According to an aspect of the disclosure there is provided an apparatus including one or more processor and a non-transitory computer-readable memory. The non-transitory computer-readable memory having stored thereon processor executable instructions, that when executed by the one or more processors, cause the apparatus to: receive at least one SSB in a frame; detect the at least one SSB; determine a location of a physical resource including a PDCCH carrying SIB control information; and determine a timing reference point from a SIB that is locatable using the SIB control information.

According to an aspect of the disclosure there is provided method for initial access involving: transmitting at least one SSB in a frame, the at least one SSB being used by a wireless device to determine a location of physical resource including a PDCCH carrying SIB control information and the SIB control information used to locate an SIB by the wireless device in order to determine a timing reference point.

In some embodiments, frame timing is determined based on the detected SSB and the frame timing is used for control resource set 0 (CORESET0) time location determination and SIB1 detection.

In some embodiments, a second frame timing is based on the timing reference point, wherein the second frame timing is used for physical channel transmission.

In some embodiments, the timing reference point is expressed in the form of at least one of: a) a reference SFN plus an offset to the timing reference point; b) an offset to the timing reference point, the offset with reference to a reference system frame that is pre-defined to be a SFN where SIB that includes the timing reference point is located; or c) an absolute timing value.

In some embodiments, the method further involving transmitting RO configuration information indicating locations available for transmission of a RACH preamble by the wireless device.

In some embodiments, the method further involving determining a RO for transmitting the RACH preamble based on the RO configuration information, wherein the RO is based on: a SFN or a slot index or a symbol index with reference to frame timing based on the SSB; or a SFN or a slot index or a symbol index with reference to frame timing based on the timing reference point.

In some embodiments, the method further involving receiving the RACH preamble in a MSG1 transmission.

In some embodiments, the method further involving transmitting a RAR in a MSG2 transmission.

In some embodiments, the method further involving receiving a MSG3 transmission based on: a SFN or slot index or symbol index with reference to the frame timing based on the SSB; or a SFN or slot index or symbol index with reference to the frame timing based on the timing reference point.

In some embodiments, the method further involving transmitting a MSG4 transmission based on: an SFN or slot index or symbol index with reference to the frame timing based on the SSB; or a SFN or slot index or symbol index with reference to the frame timing based on the timing reference point.

In some embodiments, the method further involving transmitting information indicative of a SFN of a starting frame in a frame structure, wherein a starting boundary of the starting frame is aligned with the timing reference point.

In some embodiments, a SFN of a starting frame in frame structure is determined according to a predetermined rule, wherein a starting boundary of the starting frame is aligned with the timing reference point.

In some embodiments, the predetermined rule: indicates that the SFN of the starting frame is to be updated based on the timing reference point; indicates that the starting frame is SFN0 in a frame structure updated based on the timing reference point; or indicates that the SFN of the starting frame is determined based on a starting frame of a frame structure having a different timing reference point, wherein the starting boundary of the frame structure is aligned with the different timing reference point.

According to an aspect of the disclosure there is provided an apparatus including one or more processor configured to: transmit at least one SSB in a frame, the at least one SSB being used by a wireless device to determine a location of a physical resource including a PDCCH carrying SIB control information and the SIB1 information used to locate an SIB by the wireless device in order to determine a timing reference point.

According to an aspect of the disclosure there is provided an apparatus including one or more processor and a non-transitory computer-readable memory. The non-transitory computer-readable memory having stored thereon processor executable instructions, that when executed by the one or more processors, cause the apparatus to: transmit at least one SSB in a frame, the at least one SSB being used by a wireless device to determine a location of a physical resource including a PDCCH carrying SIB control information and the SIB1 information used to locate an SIB by the wireless device in order to determine a timing reference point.

According to an aspect of the disclosure there is provided a method involving: determining a downlink (DL) frame timing for a terminal side device according to a DL timing reference point and a propagation delay between the terminal side device and the network side device, wherein determining the DL frame timing includes determining a boundary of at least one of a frame, a slot, or a symbol.

In some embodiments, determining the DL frame timing involves receiving, by the terminal side device, an indication of the DL timing reference point at the network side device in the form of a first absolute time value; detecting, by the terminal side device, a SSB in a frame that corresponds to the DL timing reference point at the network side device in the form of a second absolute time value; determining, by the terminal side device, the propagation delay as a difference between the second and first absolute time values.

In some embodiments, determining the DL frame timing involves receiving, by the terminal side device, a terminal side device-specific signal including an indication of the propagation delay from the network side device.

In some embodiments, determining the DL frame timing involves receiving, by the terminal side device, a terminal side device-specific signal including an indication of the DL timing reference point at the terminal side device, which is a pre-compensated value of the DL timing reference point at the network side device based on the propagation delay from the network side device to the terminal side device and the DL timing reference point at the network side device.

In some embodiments, determining the DL frame timing involves transmitting, by the network side device, an indication of the DL timing reference point at the network side device in the form of a first absolute time value.

In some embodiments, the method further involving transmitting a SSB in a frame that corresponds to the DL timing reference point at the network side device that is detected at a terminal side device at a second absolute time value.

In some embodiments, the method further involving transmitting, by the network side device, a terminal side device-specific signal includes an indication of the propagation delay.

In some embodiments, the method further involving determining, by the network side device, the DL timing reference point at the terminal side device by adding the DL timing reference point at the network side device and the propagation delay; and transmitting, by the network side device, the determined DL timing reference point at the terminal side device in a terminal side device-specific signal.

According to an aspect of the disclosure there is provided an apparatus including: one or more processor configured to: transmit at least one synchronization signal block (SSB) in a frame, the at least one SSB being used by a wireless device to determine a location of physical resource comprising a physical downlink control channel (PDCCH) carrying system information block (SIB) control information and the SIB control information used to locate an SIB by the wireless device in order to determine a timing reference point.

According to an aspect of the disclosure there is provided an apparatus including one or more processor and a non-transitory computer-readable memory. The non-transitory computer-readable memory having stored thereon processor executable instructions, that when executed by the one or more processors, cause the apparatus to: transmit at least one synchronization signal block (SSB) in a frame, the at least one SSB being used by a wireless device to determine a location of physical resource comprising a physical downlink control channel (PDCCH) carrying system information block (SIB) control information and the SIB control information used to locate an SIB by the wireless device in order to determine a timing reference point.

According to an aspect of the disclosure there is provided method involving: determining an uplink (UL) frame timing reference point at a terminal side device according to an UL timing reference point and a propagation delay between the terminal side device and the network side device, wherein determining the DL frame timing includes determining a boundary of at least one of a frame, a slot, or a symbol.

In some embodiments, determining the UL frame timing involves determining, by the network side device, the UL timing reference point at the terminal side device based on the UL timing reference point at the network side device and the propagation delay; and transmitting, by the network side device, an indication of the determined UL timing reference point at the terminal side device in a terminal side device-specific signal

In some embodiments, determining the UL frame timing involves transmitting, by the network side device, an indication of the UL timing reference point at the network side device in the form of a first absolute time value; transmitting, by the network side device, a SSB in a frame that corresponds to a second absolute time value, which enables the terminal side device to determine the UL timing reference point at the terminal side device based on subtracting the determined propagation delay from the UL timing reference point at the network side device.

In some embodiments, the method further involving receiving, by the network side device, signaling from the terminal side device at the UL timing reference point at the network side device.

In some embodiments, determining the UL frame timing involves transmitting, by the network side device, a terminal side device-specific signal including an indication of the propagation delay from the network side device to the terminal side device, wherein the propagation delay is determined based on a transmission from the terminal side device and received at the network side device.

In some embodiments, determining the UL frame timing involves: receiving, by the terminal side device, a terminal side device-specific signal includes an indication of the UL reference timing point at the terminal side device which is a pre-compensated value of the UL reference timing point at the terminal side device based on the propagation delay from the network side device to the terminal side device and the UL timing reference point at the network side device.

In some embodiments, determining the UL frame timing involves receiving, by the terminal side device, an indication of the UL timing reference point at the network side device in the form of a first absolute time value; detecting, by the terminal side device, a SSB in a frame that corresponds to a second absolute time value; determining, by the terminal side device, the propagation delay as a difference between the second and first absolute time values; and determining, by the terminal side device, the UL timing reference point at the terminal side device based on subtracting the determined propagation delay from the UL timing reference point at the network side device.

In some embodiments, the method further involving transmitting, by the terminal side device, signaling to arrive at the UL timing reference point at the network side device.

In some embodiments, determining the UL frame timing involves receiving, by the terminal side device, a terminal side device-specific signal includes an indication of the propagation delay from the network side device; determining, by the terminal side device, the UL timing reference point at the terminal side device based on subtracting the determined propagation delay from the timing reference point at the network side device.

According to an aspect of the disclosure there is provided an apparatus including one or more processor configured to: determine an uplink (UL) frame timing reference point at a terminal side device according to an UL timing reference point and a propagation delay between the terminal side device and the network side device, wherein determining the DL frame timing comprises determining a boundary of at least one of a frame, a slot, or a symbol.

According to an aspect of the disclosure there is provided an apparatus including one or more processor and a non-transitory computer-readable memory. The non-transitory computer-readable memory having stored thereon processor executable instructions, that when executed by the one or more processors, cause the apparatus to: determine an uplink (UL) frame timing reference point at a terminal side device according to an UL timing reference point and a propagation delay between the terminal side device and the network side device, wherein determining the DL frame timing comprises determining a boundary of at least one of a frame, a slot, or a symbol.

According to an aspect of the disclosure, there is provided a non-transitory computer readable storage medium, wherein the computer readable storage medium stores instructions that, when executed by a processor of an apparatus, enable the apparatus to perform a method as described above.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a communication system in which embodiments of the present disclosure may occur.

FIG. 2 is another schematic diagram of a communication system in which embodiments of the present disclosure may occur.

FIG. 3 is a block diagram illustrating units or modules in a device in which embodiments of the present disclosure may occur.

FIG. 4 is a block diagram illustrating units or modules in a device in which embodiments of the present disclosure may occur.

FIG. 5 is a schematic diagram illustrating a plurality of frames that may include signals to be transmitted by a base station (BS) and received by a user equipment (UE) in context with a timing reference point defined in relative terms, in accordance with aspects of the present application.

FIG. 6 is a schematic diagram illustrating a plurality of frames that may include signals be transmitted by a BS and received by a UE in context with a timing reference point defined in absolute terms, in accordance with aspects of the present application.

FIG. 7 is a timing diagram illustrating propagation delay between a base station transmitting a downlink (DL) signal on a resource and a resource used to detect the signal at two different UEs.

FIG. 8 is a timing diagram illustrating propagation delay between a base station transmitting a DL signal on a resource having a boundary identified with an absolute SSB transmission time and a resource used to detect the signal on a resource having a boundary identified with an absolute SSB receiving time at a UE, wherein the UE may compensate the propagation delay, according to aspects of the present disclosure.

FIG. 9 is a timing diagram illustrating propagation delay between a base station transmitting a DL signal on a resource and a resource used to detect the signal at two different UEs, where each resource used to detect the signal at the two different UEs has a different timing reference point, and wherein the base station may compensate the propagation delay, according to aspects of the present disclosure.

FIG. 10 is a timing diagram illustrating propagation delay between a base station receiving an uplink (UL) signal on a resource and a resource used to transmit the signal at two different UEs, where each resource used to transmit the signal at the two different UEs has a different timing reference point, wherein the base station may compensate the propagation delay, according to aspects of the present disclosure.

FIG. 11 illustrates a timing diagram illustrating propagation delay between a base station receiving an UL signal on a resource and a resource used to transmit the signal at two different UEs, where each resource used to transmit the signal at the two different UEs has a different timing reference point, and wherein the UE may compensate the propagation delay, according to aspects of the present disclosure.

FIG. 12 illustrates a flow chart describing how an initial access method may be performed between a UE and base station.

FIG. 13 illustrates a series of frames and a timing reference point at the beginning of one of the frames showing an example of a first type of frame timing based on the timing reference point, according to aspects of the present disclosure.

FIG. 14 illustrates a series of frames, in which one frame includes SSB, showing an example of a second frame timing, that is not based on a timing reference point, but based on SSB detection, to define frame timing, according to aspects of the present disclosure.

FIG. 15 illustrates a series of frames, in which one frame includes SSB, and how frame timing may occur for transmission of a preamble on a random access channel (RACH) in the case of a reference timing point frame timing and in the case of a non-reference point timing frame timing, according to aspects of the present disclosure.

FIG. 16 illustrates a series of frames, in which one frame includes SSB, and how a UE may use only a timing reference point type of frame timing, according to aspects of the present disclosure.

FIG. 17 illustrates a signal flow diagram for signaling between a BS and a UE illustrating an example process for supporting network communication, in accordance with embodiments of the present disclosure.

### DETAILED DESCRIPTION OF THE ILLUSTRATIVE EMBODIMENTS

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

Aspects of the present disclosure may provide methods, apparatuses and devices for enabling timing reference point alignment for DL and UL by compensating for propagation delay. In some embodiments, the propagation delay may be compensated by the network or a network-side device, such as a base station. In some embodiments, the propagation delay may be compensated by terminal side device, such as a UE.

Aspects of the present disclosure may provide methods, apparatuses and devices for using one or more types of frame timing as part of an initial access method. In some embodiments, the terminal side device may use timing reference point frame timing to detect a synchronization signal block (SSB). Based on information in the SSB, the terminal side device may determine whether timing reference point information has been updated. The terminal side device then continues to use the reference timing point frame timing for other signaling.

In some embodiments, the terminal side device may detect a SSB using a non-reference timing point frame timing. Based on information in the SSB, the terminal side device may be able to determine timing reference point information. The terminal side device may then be able to use the reference timing point frame timing for other signaling after the timing reference point information has been determined by the non-reference timing point frame timing. Using the non-reference timing point time frame initially may aid in detecting the SSB and determining a timing reference point indication, without being aware of an initial timing reference point.

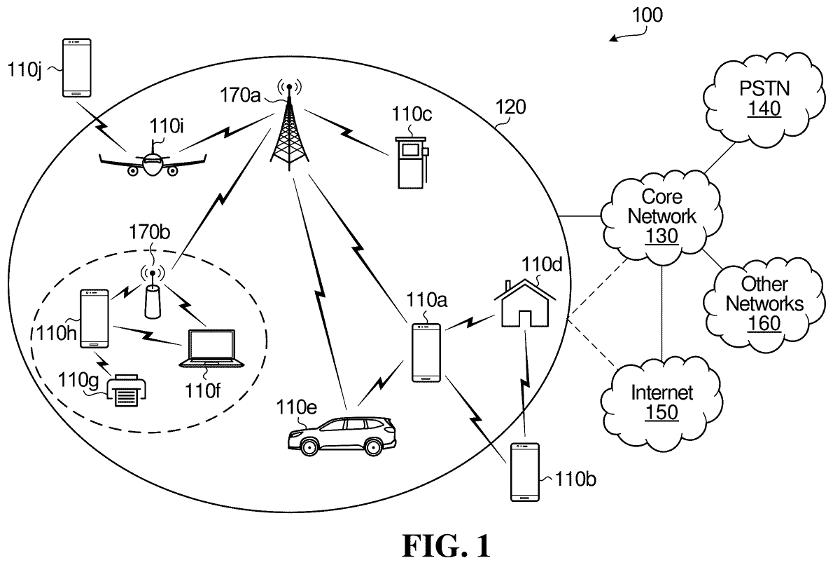

FIGS. 1, 2, and 3 following below provide context for the network and device that may be in the network and that may implement aspects of the present disclosure.

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

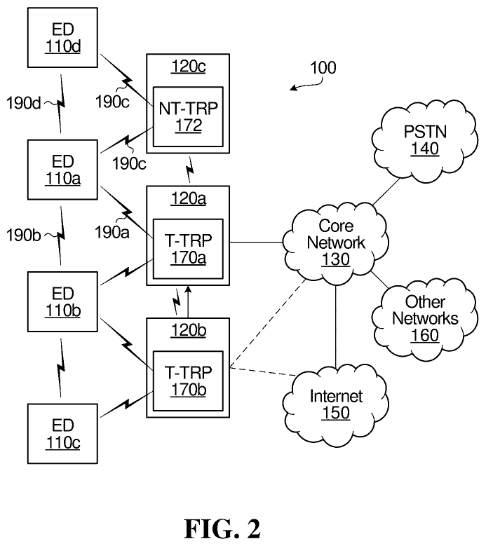

FIG. 2 illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a PSTN 140, the Internet 150, and other networks 160. While certain numbers of these components or elements are shown in FIG. 2, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, terminal side device, or consumer electronics device.

FIG. 2 illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110d, radio access networks (RANs) 120a-120c, a core network 130, a public switched telephone network (PSTN) 140, the internet 150, and other networks 160. Although certain numbers of these components or elements are shown in FIG. 2, any reasonable number of these components or elements may be included in the communication system 100.

The EDs 110a-110d are configured to operate, communicate, or both, in the communication system 100. For example, the EDs 110a-110d are configured to transmit, receive, or both, via wireless or wired communication channels. Each ED 110a-110d represents any suitable end user device for wireless operation and may include such devices (or may be referred to) as a UE, WTRU, mobile station, fixed or mobile subscriber unit, cellular telephone, STA, MTC device, PDA, smartphone, laptop, computer, tablet, wireless sensor, or consumer electronics device.

In FIG. 2, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 172 may be a non-terrestrial base station, or non-terrestrial TRP (NT-TRP), that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110d may be alternatively or additionally configured to interface, access, or communicate with any other base station 170a-170b, the internet 150, the core network 130, the PSTN 140, the other networks 160, or any combination of the preceding.

The EDs 110a-110d and base stations 170a-170b, 172 are examples of communication equipment that can be configured to implement some or all of the operations and/or embodiments described herein. In the embodiment shown in FIG. 2, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b, 172 communicate with one or more of the EDs 110a-110c over one or more air interfaces 190a, 190c using wireless communication links e.g. radio frequency (RF), microwave, infrared (IR), etc. The air interfaces 190a, 190c may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a, 190c.

A base station 170a-170b, 172 may implement Universal Mobile Telecommunication System (UMTS) Terrestrial Radio Access (UTRA) to establish an air interface 190a, 190c using wideband CDMA (WCDMA). In doing so, the base station 170a-170b.172 may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b,172 may establish an air interface 190a,190c with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1X, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110d communicate with one another over one or more sidelink (SL) air interfaces 190b, 190d using wireless communication links e.g. radio frequency (RF), microwave, infrared (IR), etc. The SL air interfaces 190b, 190d may utilize any suitable radio access technology, and may be substantially similar to the air interfaces 190a, 190c over which the EDs 110a-110c communication with one or more of the base stations 170a-170b, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 190b, 190d. In some embodiments, the SL air interfaces 180 may be, at least in part, implemented over unlicensed spectrum.

In addition, some or all of the EDs 110a-110d may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110d may be multimode devices capable of operation according to multiple radio access technologies, and incorporate multiple transceivers necessary to support multiple radio access technologies.

In some embodiments, the signal is transmitted from a terrestrial BS to the UE or transmitted from the UE directly to the terrestrial BS and in both cases the signal is not reflected by a RIS. However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

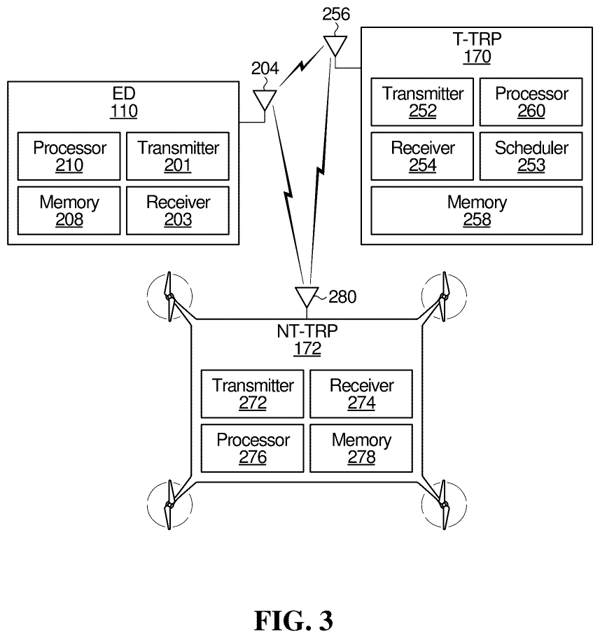

FIG. 3 illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1 or 2). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 3. FIG. 3 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

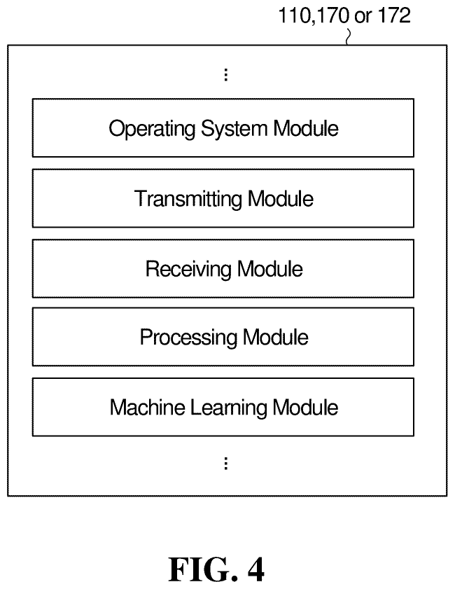

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprise several frameworks, e.g., distributed machine learning and federated learning. AI/ML architectures comprises intelligent controller which can perform as single agent or multi-agent, based on joint optimization or individual optimization. New protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data intensive. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

Control information is referenced in some embodiments herein. Control information may sometimes instead be referred to as control signaling, or signaling. In some cases, control information may be dynamically communicated, e.g. in the physical layer in a control channel, such as in a physical uplink control channel (PUCCH) or physical uplink shared channel (PUSCH) or physical downlink control channel (PDCCH). An example of control information that is dynamically indicated is information sent in physical layer control signaling, e.g., uplink control information (UCI) sent in a PUCCH or PUSCH or downlink control information (DCI) sent in a PDCCH. A dynamic indication may be an indication in a lower layer, e.g., physical layer/layer 1 signaling, rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling (such as RRC signaling), and/or a MAC CE. Dynamic signaling, as used herein, may refer to signaling that is dynamic, e.g., physical layer control signaling sent in the physical layer, such as DCI sent in a PDCCH or UCI sent in a PUCCH or PUSCH.

In current networks, frame timing and synchronization may be established based on synchronization signals, such as a primary synchronization signal (PSS) and a secondary synchronization signal (SSS). Notably, known frame timing and synchronization strategies involve adding a timestamp, e.g., (xx0:yy0:zz), to a frame boundary, where xx0, yy0, zz in the timestamp may represent a time format such as hour, minute, and second, respectively. Further granularity of time is possible by the time stamp including fields for one or more of milliseconds, microseconds and nanoseconds.

It is anticipated that diverse applications and use cases in future networks, such as 6G networks, may involve usage of different periods of frames, slots and symbols to satisfy different requirements, functionalities, and quality of service (QoS) types. It follows that usage of different periods of frames to satisfy the different requirements, functionalities, and QoS types may present challenges for frame timing alignment for various frame structures. One example might be frame timing alignment for a time-divisional duplex (TDD) configuration in neighboring carrier frequency bands or among sub-bands (or bandwidth parts) of one channel or carrier bandwidth.

The present disclosure relates generally to wireless communications, and in particular to methods and apparatuses for supporting network communication using configuration information for enabling timing alignment or frame timing alignment. The timing alignment or frame timing alignment may be carried out in terms of use of a timing reference point indicative of a boundary (e.g., a starting boundary or an ending boundary) of a frame, a sub-frame, a symbol, or a slot. It should be noted that the timing alignment or frame timing alignment in the present disclosure is more general, not limited to the cases where a timing alignment or frame timing alignment is carried out in connection with a frame boundary only. Also, in the present disclosure, relative timing to a frame or frame boundary should be interpreted in a more general sense, e.g., the frame boundary means a timing point (e.g., starting or ending boundary) of a frame, or a timing point (e.g., starting or ending boundary) of a frame element, such as a symbol, a slot or a subframe, within the frame. In the present disclosure, the expressions “(frame) timing alignment”, “timing realignment” and “relative timing to a frame boundary” are used in a more general sense as described above.

According to some aspects of the present disclosure, a timing reference point may be used to align or re-align boundaries of frames of a terminal side apparatus (e.g., user equipment (UE)) with boundaries of frames of a network side apparatus (e.g., base station (BS)) for transmissions within the same cell/carrier or transmissions across neighboring carrier frequency bands.

According to some aspects of the present disclosure, a timing reference point may be used to align or re-align boundaries of frames of a first terminal side apparatus (e.g., user equipment (UE)) with boundaries of frames of a second terminal side apparatus (e.g., another UE) for transmissions within the same cell/carrier.

In some aspects of the present disclosure, a network side apparatus (e.g., BS) associated with a cell may transmit, to a terminal side apparatus (e.g., user equipment (UE)), a timing alignment indication message including configuration information for timing alignment. The configuration information for timing alignment may configure or provide a timing reference point. For example, the configuration information may include a timing reference point or information indicative of a timing reference point. The timing reference point may be indicative of a boundary of a frame structure and be used by the terminal side apparatus (e.g., UE) in a given cell, when performing a timing alignment or timing realignment. The configuration information in the timing alignment indication message may include a relative timing indication, At, to a boundary of a frame structure. The relative timing indication, At, may express the timing reference point as occurring a particular duration, i.e., At, subsequent to a boundary of a given frame.

The configuration information in the timing alignment indication message may also include a system frame number (SFN) for the given frame. The SFN may be also referred to as SFN index. The SFN may be a value in a range from 0 to 1023, inclusive. When the SFN is a number within this range, 10 bits may be used to represent the SFN. In a particular implementation, when an SFN is carried by a synchronization signal block (SSB), six of the 10 bits for the SFN may be carried in a Master Information Block (MIB) and the remaining four bits of the 10 bits of the SFN may be carried in a Physical Broadcast Channel (PBCH) payload.

Optionally, the configuration information in the timing alignment indication message may also include other parameters, such as a minimum time offset. The minimum time offset may establish a minimum duration of time preceding the timing reference point. The terminal side apparatus (e.g., UE) may rely upon the minimum time offset as an indication that downlink (DL) signaling, including the timing alignment indication message, may allow the terminal side apparatus enough time for detecting the configuration information in the timing alignment indication message, to obtain the timing reference point.

Various aspects of the present disclosure are illustrated in the context of a UE and a BS. However, it should be noted that the UE and BS in the present disclosure are not intended to be construed in a limiting sense. The UE and BS are instead used in a more general sense, such that a UE refers to any applicable terminal side apparatus operating in accordance with various aspects described in the present disclosure or a terminal device comprising such apparatus and a BS refers to any applicable network side apparatus operating in accordance with various aspects described in the present disclosure or a network device comprising such apparatus.

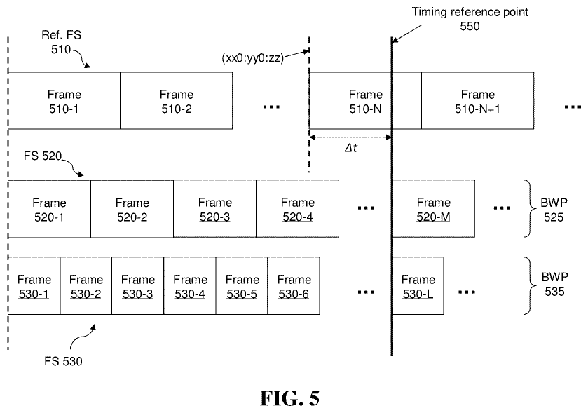

FIG. 5 is a diagram illustrating a plurality of frames that may include one or more signals to be transmitted by a base station (BS) and received by a user equipment (UE) in context with a timing reference point defined in relative terms, in accordance with aspects of the present application. Frame structure 510 may be a reference frame structure. The frame structure 510 may include reference frames 510-1, 510-2, . . . , 510-N, 510-N+1. The reference frame 510-N is illustrated, in FIG. 5, as having a frame boundary timestamp, xx0:yy0:zz, indicative of the time at which a starting boundary of the reference frame 510-N is located. In other words, the starting boundary of the frame 510-N is time stamped at xx0:yy0:zz, as shown in FIG. 5. The timestamp format (xx0:yy0:zz) may indicate, for example as (xx0) hour, (yy0) minute and (zz) second, respectively. While not explicitly described in FIG. 5, in some embodiments, the starting boundary of the frame 510-N may be time stamped at xx0:yy0:zz:aa:bb:cc, where the timestamp format (xx0:yy0:zz:aa:bb:cc) may indicate, for example as (xx0) hour, (yy0) minute, (zz) second, (aa) milliseconds, (bb) microseconds, and (cc) nanoseconds, respectively. However, in some embodiments, the time stamp may be (xx0:yy0:zz:aa) or (xx0:yy0:zz:aa:bb), depending on the granularity of the time stamp. Frame structure 520 may include a first plurality of frames 520-1, 520-2, 520-3, 520-4, . . . , 520-M. Frame structure 530 may include a second plurality of frames 530-1, 530-2, 530-3, 530-4, 530-5, 530-6, . . . , 530-L. A timing reference point 550 may be obtained based on configuration information received from a BS or a different UE. The configuration information may include identification of the timing reference point 550 or information indicative of the timing reference point 550.

Still referring to FIG. 5, one or more signals in the first plurality of frames 520-1, 520-2, 520-3, 520-4, . . . , 520-M may be transmitted or received at a first bandwidth part (BWP) 525, and one or more signals in the second plurality of frames 530-1, 530-2, 530-3, 530-4, 530-5, 530-6, . . . , 530-L may be transmitted or received at a second BWP 535. It may further be the case that the signals in the first BWP 525 and the second BWP 535 are transmitted or received in two sub-bands within one carrier frequency band or in two sub-bands in adjacent carrier frequency bands.

The timing alignment indication message that includes configuration information for timing alignment may be transmitted from a BS via a DL signaling. The DL signaling may be implemented as cell specific signaling (e.g., group-common signaling, paging signaling, broadcast signaling) or as UE specific signaling (e.g., paging signaling, unicast signaling, modified downlink control information (DCI) signaling, media access control-control element (MAC-CE) signaling, or radio resource control (RRC) signaling).

The UE may monitor the DL signaling to detect the timing alignment indication message including the configuration information for timing alignment. As described above, the DL signaling may be implemented as cell specific signaling or as UE specific signaling. The DL signaling may be associated with the configuration of a timing reference point indicative of a boundary of a frame structure. After receiving the timing alignment indication message, the UE may adjust its frame boundary to be timing aligned with the timing reference point 550, as shown in FIG. 5. The timing reference point 550 may be defined in terms of a relative timing indication, Δt with respect to a timestamp, xx0:yy0:zz. The relative timing indication Δt may be defined in a unit of time, e.g., milliseconds or microseconds or nanoseconds, and anchored to the starting boundary of the frame 510-N. As noted above, the starting boundary of the frame 510-N may be time stamped at xx0:yy0:zz, xx0:yy0:zz:aa, xx0:yy0:zz:aa:bb, or xx0:yy0:zz:aa:bb:cc. Therefore, the new frame boundary at the timing reference point 550 may be understood to be time stamped with a value equivalent to xx0:yy0:zz+Δt or one of the variations described above +Δt.

The UE may receive the timing alignment indication message at a time offset, T_{offset}. The time offset, T_{offset}, may be a delay (e.g., propagation delay) before configuring or obtaining the timing reference point. The delay may comprise a propagation delay between the BS and the UE. In some cases, the delay may comprise time taken for detecting the configuration information after receiving the timing alignment indication message. The time offset, T_{offset}, may be configured by RRC signaling. The time offset, T_{offset}, may be also included in the timing alignment indication message (e.g., included in the configuration information).

Once the timing reference point 550 is obtained, the frames in the first BWP 525 and the second BWP 535 may be aligned with the timing reference point 550. Specifically, for example, a starting boundary of the frame 520-M and a starting boundary of the frame 530-L are aligned with the timing reference point 550, respectively, as shown in FIG. 5.

Upon configuring the timing reference point 550 for the first BWP 525 and the second BWP 535, the UE may start transmitting or receiving information in a frame 520-M in the BWP 525, the transmitting or receiving starting from the timing reference point 550. Additionally, upon configuring the timing reference point 550, the UE may start transmitting or receiving information in a frame 530-L in the BWP 535, the transmitting or receiving starting from the timing reference point 550. In some embodiments, the second BWP 535 may be used by a different UE to start transmitting or receiving information in a frame 530-L.

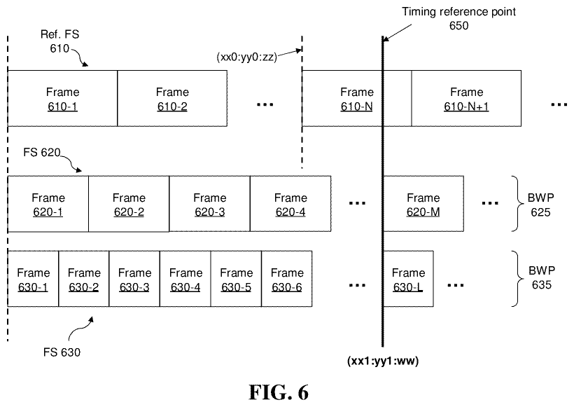

FIG. 6 is a diagram illustrating a plurality of frames that may include one or more signals to be transmitted by a base station (BS) and received by UE in context with a timing reference point defined in absolute terms, in accordance with aspects of the present application. Frame structure 610 may be a reference frame structure. The plurality of frames in the reference frame structure 610 may include reference frames 610-1, 610-2, . . . , 610-N, 610-N+1. The reference frame 610-N is illustrated, in FIG. 6, having a frame boundary timestamp, xx0:yy0:zz, xx0:yy0:zz:aa:bb:cc or other as described above, indicative of the time at which a starting boundary of the reference frame 610-N is located. Frame structure 620 may include a first plurality of frames 620-1, 620-2, 620-3, 620-4, . . . , 620-M. Frame structure 630 may include a second plurality of frames 630-1, 630-2, 630-3, 630-4, 630-5, 630-6, . . . , 630-L. A timing reference point 650 may be obtained based on configuration information received from a BS or a different UE. The configuration information may include identification of the timing reference point 650 or information indicative of the timing reference point 650.

Still referring to FIG. 6, one or more signals in the first plurality of frames 620-1, 620-2, 620-3, 620-4, . . . , 620-M may be transmitted or received at a first bandwidth part (BWP) 625, and one or more signals in the second plurality of frames 630-1, 630-2, 630-3, 630-4, 630-5, 630-6, . . . , 630-L may be transmitted or received at a second BWP 635. It may further be the case that the signals in the first BWP 625 and the second BWP 635 are transmitted or received in two sub-bands within one carrier frequency band or in two sub-bands in adjacent carrier frequency bands.

The timing alignment indication message that includes configuration information for timing alignment may be transmitted from a BS via a DL signaling. The DL signaling may be implemented as cell-specific signaling (e.g., group-common signaling, paging signaling, broadcast signaling) or as UE specific signaling (e.g., paging signaling, unicast signaling, modified downlink control information (DCI) signaling, media access control-control element (MAC-CE) signaling, or radio resource control (RRC) signaling).

The UE may monitor the DL signaling to detect the timing alignment indication message including the configuration information for timing alignment. As described above, the DL signaling may be implemented as cell-specific signaling or as UE specific signaling. The DL signaling may be associated with the configuration of a timing reference point indicative of a boundary of a frame structure. After receiving the timing alignment indication message, the UE may adjust its existing frame boundary to be timing aligned with the timing reference point 650. The timing reference point 650 may be defined in terms of an absolute timing indication, for example, a timestamp xx1:yy1:ww or xx1:yy1:ww:aa1 or xx1:yy1:ww:aa1:bb1 or XX1:yy1:ww:aa1:bb1:cc1 (not shown in FIG. 6). The timestamp format (xx1:yy1:ww) may indicate, for example as (xx1) hour, (yy1) minute and (ww) second, respectively. The timestamp format may indicate, for example additional granularity in the form of (aa1) milliseconds, (bb1) microseconds, and (cc1) nanoseconds, respectively. Put another way, the new frame boundary at the timing reference point 650 may be understood to be time stamped with a value equivalent to xx1:yy1:ww or other variations consistent with further granularity as described above.

The UE may receive the timing alignment indication message at a time offset, T_{offset}. The time offset, T_{offset}, may be a delay that is similar to the time offset T_{offset} described above in connection with FIG. 5.

Once the timing reference point 650 is obtained, the frames in the first BWP 625 and second BWP 635 may be aligned with the timing reference point 650. Specifically, for example, a starting boundary of the frame 620-M and a starting boundary of the frame 630-L are aligned with the timing reference point 650, respectively, as shown in FIG. 6.

Upon configuring the timing reference point 650, the UE may start transmitting or receiving information in a frame 620-M in the first BWP 625, the transmitting or receiving starting from the timing reference point 650. Additionally, upon configuring the timing reference point 650, the UE may start transmitting or receiving information in a frame 630-L in the second BWP 635, the transmitting or receiving starting from the timing reference point 650. In some embodiments, the second BWP 635 may be used by a different UE to start transmitting or receiving information in a frame 630-L.

Aspects of the present disclosure provide methods and apparatus for alignment of absolute timing reference points for one or more terminal side device, such as a UE with regard to a network side device, such as a base station. In some embodiments, the network side device, or a terminal side device may pre-compensate for propagation delay between the network side device and the terminal side device. In some embodiments, the timing reference point may be a timing reference point for downlink (DL) signaling from a network side device to a terminal side device. In some embodiments, the timing reference point may be a timing reference point for uplink (UL) signaling from a terminal side device to a network side device.

Aspects of the present disclosure provide methods and apparatus for alignment of timing reference points as part of an initial access procedure. In some embodiments, in order to enable alignment of timing reference points as part of an initial access procedure, a frame structure may be defined in terms of a non-timing reference point frame timing. An example of a non-timing reference point frame timing involves the terminal side device detecting a SSB. The terminal side device detects a physical downlink control channel (PDCCH) in control resource set 0 (CORESET0), which enables the terminal side device to detect one or more system information blocks (SIBs), such as SIB1, which may include a timing reference point to be used by the terminal side device. As such, the terminal side device may determine a timing reference point during initial access before the terminal side device has otherwise explicitly been provided the timing reference point.

In some embodiments, upon determining the timing reference point during the non-timing reference point frame timing, the UE may then utilize the timing reference point for transmission and receiving of other signal or channels following the initial access.

In some embodiments, upon determining the timing reference during the non-timing reference point frame timing, the UE may still utilize timing based on the during the non-timing reference point frame timing for transmission and receiving of other signal or channels following the initial access.

For a transmission between a network side device, such as a base station, and a terminal side device, such as a UE, whether the transmission is in the UL or DL direction, due to signal propagation delay, a timing reference point may not be aligned between the UE and the base station. For example, in a DL direction, when the base station sends a signal starting at an absolute DL timing reference point, the base station may assume the UE receives the signal at the DL timing reference point, but due to propagation delay, the UE receives the signal subsequent to the absolute time of the DL timing reference point.

In order to align the DL timing reference point for multiple UEs in a telecommunications cell served by the base station, UE specific propagation delay should be considered. When UEs are located different distances from the base station, the propagation delay may be different. Even if UEs are a same distance from the base station, but are located in somewhat different or very different directions with respect to the base station, the UE's may have different propagation delay due to obstructions in the respective paths of the signals or reflections of the signals.

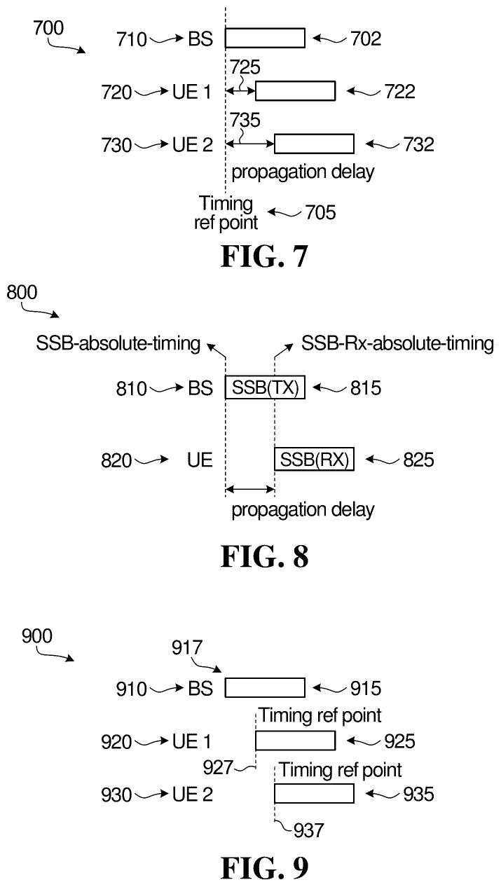

FIG. 7 illustrates a timing diagram 700 showing a first resource 702 used for transmitting a signal starting at a particular timing reference point 705 from a base station 710 and the second and third resources 722 and 732 where the signal transmitted by the base station 710 is received by UE1 720 and UE2 730, respectively. There is a first propagation delay 725 between the start of the first resource 702 for transmission of the signal by the base station 710 and the start of the second resource 722 for receipt of the signal at UE1 720 and a second propagation delay 735 between the start of the first resource 702 for transmission of the signal by the base station 710 and the start of the third resource 732 for receipt of the signal at UE2 730. The first propagation delay 725 and the second propagation delay 735 are different in duration.

In some embodiments, the base station may compensate for the propagation delay in the DL timing reference point between the base station and the UE. In some embodiments, the UE may compensate for the propagation delay in the DL timing reference point between the base station and the UE.

Alignment of the DL timing reference point for the base station and the UE means that when the base station sends a signal at the DL timing reference point at base station side, the UE receives the signal at the DL timing reference point at the UE side, with the propagation delay being compensated for. Similarly, alignment of the UL timing reference point for the base station and the UE means that when the UE sends a signal at the UL timing reference point at the UE side, the base station receives the signal at the UL timing reference point at the base station side, with the propagation delay being compensated for.

As mentioned above, in some embodiments, the UE compensates for the propagation delay. For example, a UE may consider the timing reference point from the UE point of view as equal to the base station's indicated DL timing reference point plus the propagation delay between the base station and the UE.

In some embodiments, the propagation delay may be determined by the UE as a difference between an absolute timing value when SSB is received at the UE and the absolute timing value of transmission of the SSB at the base station that has been provided to the UE.

The base station indicates to the UE an absolute timing for a start time boundary, or an end time boundary, of the SSB, i.e. SSB-TX absolute-timing. This indication may be sent by broadcast signalling, such as a master information block (MIB) or a SIB, or may be sent by RRC signaling, MAC-CE signaling or DCI signalling. Upon receiving the SSB, the UE may obtain the exact time that the UE detects the start time boundary, or the end time boundary, of the SSB, i.e. SSB-RX-absolute-timing. The SSB-TX absolute-timing and SSB-RX-absolute-timing values may be absolute timing values based on a global clock, such as a GPS signal. By calculating the time difference between SSB-RX-absolute-timing and SSB-absolute-timing, the UE determines the propagation delay.

FIG. 8 illustrates an example of a timing diagram 800 showing a first resource 815 for transmitting an SSB at the base station 810 and a second resource 825 for receiving the SSB transmitted by the base station 810 at the UE 820. A starting boundary of the first resource 815 is indicated as SSB-TX absolute-timing and a starting boundary of the second resource 825 is indicated as SSB-RX-absolute-timing. The propagation delay equals SSB-RX-absolute-timing−SSB-TX-absolute-timing.

In some embodiments, the base station indicates the propagation delay between the UE and the base station to the UE. The base station may determine the propagation delay be knowing when a UE was scheduled to transmit a signal and when the base station actually received the signal. A particular example of how the base station may determine the propagation delay involves receiving a signal on a physical random access channel (PRACH). However, it is to be understood that they may be any number of ways that the base station may be able to determine the propagation delay. The base station indicates the propagation delay to the UE by broadcast signalling or UE-specific signalling, which may include any one or more of random access response (RAR) signaling, RRC signaling, MAC-CE signaling, or DCI signaling.

As mentioned above, in some embodiments, the base station compensates for the propagation delay. In such an implementation, the UE may consider the DL timing reference point from the UE point of view as equal to the base station's indicated DL timing reference point as the base station has provided a DL timing reference point that has pre-compensated for the propagation delay, i.e. the indicated DL Timing Reference Point for the UE equals a timing reference point at base station side plus the propagation delay between the UE and the base station.

FIG. 9 illustrates an example of a timing diagram 900 showing a first resource 915 for transmitting an SSB at the base station 910, a second resource 925 for receiving the SSB transmitted by the base station 910 at a first UE UE1 920 and a third resource 935 for receiving the SSB transmitted by the base station 910 at a second UE UE2 930. A starting boundary of the first resource 915 is considered as the DL timing reference point 927 for the BS 910. A starting boundary of the second resource 925 that includes compensated propagation delay is considered as the DL timing reference point 927 for the first UE UE1 920 and a starting boundary of the third resource 935 that includes compensated propagation delay is considered as the DL timing reference point 937 for the second UE UE2 930.

The signaling by the base station indicating the pre-compensated DL timing reference point should be UE-specific because different UEs may have different propagation delay. The signaling by the base station indicating the pre-compensated DL timing reference point may be sent using any of one or more of RRC, MAC-CE or DCI.

Some embodiments of the disclosure provide a method that involves determining a DL frame timing for a terminal side device according to a DL timing reference point and a propagation delay between the terminal side device and the network side device, wherein determining the DL frame timing comprises determining a boundary of at least one of a frame, a slot, or a symbol.

From the perspective of the terminal side device, determining the DL frame timing may involve receiving, by the terminal side device, an indication of the DL timing reference point at the network side device in the form of a first absolute time value. The method may also include detecting, by the terminal side device, a SSB in a frame that corresponds to the DL timing reference point at the network side device in the form of a second absolute time value. Another step of the method may include determining, by the terminal side device, the propagation delay as a difference between the second and first absolute time values.

In some embodiments, determining the DL frame timing involves receiving, by the terminal side device, a terminal side device-specific signal including an indication of the propagation delay from the network side device.

In some embodiments, determining the DL frame timing involves receiving, by the terminal side device, a terminal side device-specific signal including an indication of the DL timing reference point at the terminal side device, which is a pre-compensated value of the DL timing reference point at the network side device based on the propagation delay from the network side device to the terminal side device and the DL timing reference point at the network side device.

From the perspective of the network side device, determining the DL frame timing may involve transmitting, by the network side device, an indication of the DL timing reference point at the network side device in the form of a first absolute time value.

In some embodiments, transmitting a SSB in a frame that corresponds to the DL timing reference point at the network side device that is detected at a terminal side device at a second absolute time value.

In some embodiments, the method further involves transmitting, by the network side device, a terminal side device-specific signal including an indication of the propagation delay.

In some embodiments, the method further involves determining, by the network side device, the DL timing reference point at the terminal side device by adding the DL timing reference point at the network side device and the propagation delay. The method may also involve transmitting, by the network side device, the determined DL timing reference point at the terminal side device in a wireless communication device-specific signal.

In order to align the UL timing reference point, UE specific propagation delay should be considered. Because UEs may be located different distances from the base station, or at least have different propagation paths between base station and UE, the propagation delay may be different. Even if UEs are a same distance from the base station, but are located in different directions with respect to the base station, the UE's may have different propagation delay due to obstructions in the path of the signal or reflections of the signal.

In some embodiments, the base station may compensate for the propagation delay in the UL timing reference point between the base station and the UE. In some embodiments, the UE may compensate for the propagation delay in the UL timing reference point between the base station and the UE.

Alignment of the UL timing reference point for the base station and the UE means that when the UE sends a signal at the UL timing reference point at the UE side, the base station receives the signal at the UL timing reference point at the base station side, with the propagation delay being compensated for.

As mentioned above, in some embodiments, the base station compensates for the propagation delay in the UL timing reference point. In such an implementation, the UE may consider the UL timing reference point from the UE point of view as equal to the base station's indicated UL timing reference point as the base station has provided an UL timing reference point that has pre-compensated for the propagation delay, i.e. the indicated UL Timing Reference Point for the UE equals the UL timing reference point at base station side minus the propagation delay between the UE and the base station.

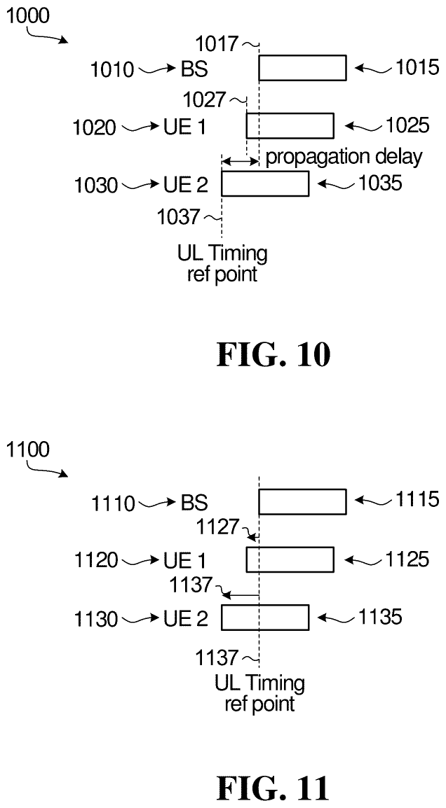

FIG. 10 illustrates an example of a timing diagram 1000 showing a first resource 1015 for receiving a signal at the base station 1010 transmitted from at least one of a first UE UE1 1020 or a second UE2 1030, a second resource 1025 for transmitting by the first UE1 1020 and a third resource 1035 for transmitting by the second UE UE2 1030. A starting boundary of the first resource 1015 is considered as the UL timing reference point 1017 for the BS 1010. A starting boundary of the second resource 1025 is considered as the UL timing reference point 1027 for the first UE UE1 1020 and a starting boundary of the third resource 1035 is considered as the UL timing reference point 1037 for the second UE UE2 1030.

At the UE, the UE's understanding of the UL Timing Reference Point is that the UE's timing reference point is equal to the base station's indicated UL timing reference point minus the propagation delay between the UE and the base station. In some embodiments, a timing advance (TA) indication is not used. In some embodiments, a random access response (RAR) may be used to indicate a UL timing reference point.

In some embodiments, the base station provides the UE a pre-compensated UL timing reference point as a starting boundary of a frame or a subframe or a slot or a symbol. The base station pre-compensates the propagation delay into the UL timing reference point, i.e. the indicated UL timing reference point for a UE equals the UL timing reference point at the base station side minus the propagation delay between the UE and the base station.

The signaling by the base station indicating the pre-compensated UL timing reference point is UE-specific because different UEs may have different propagation delay. The signaling by the base station indicating the pre-compensated UL timing reference point may be sent using any of RRC, MAC-CE or DCI.

In some embodiments, at the UE, the UE's understanding of the UL timing reference point is equal to the UL timing reference point at the base station, which is indicated by the base station, minus the propagation delay. The propagation delay obtained by the UE or may be provided by the base station.

In some embodiments, the propagation delay may be obtained by the UE. For example, the propagation delay may be determined by the UE as a difference between an absolute timing value receipt of SSB at the UE and the transmission of the SSB at the base station.

The base station indicates to the UE an absolute timing for a start time boundary or an end time boundary of the SSB, i.e. SSB-TX absolute-timing. This indication may be sent by broadcast signalling, such as a MIB or a SIB or may be sent by RRC signaling, MAC-CE signaling or DCI signalling. Upon receiving the SSB, the UE may obtain the exact time for the start time boundary or the end time boundary of the SSB, i.e. SSB-RX-absolute-timing. The SSB-TX absolute-timing and SSB-RX-absolute-timing values may be absolute timing values based on a global clock, such as a GPS signal. By calculating the time difference between SSB-RX-absolute-timing and SSB-TX-absolute-timing, the UE determines the propagation delay.

In some embodiments, the propagation delay may be provided to the UE by the base station and then the UE may determine the UL timing reference point for the UE based on knowledge of the UL timing reference point for the base station and the propagation delay provided by the base station. The base station indicates the propagation delay to the UE by broadcast signalling or UE-specific signalling, which may include any of random access response (RAR) signaling, RRC signaling, MAC-CE signaling, or DCI signaling.

FIG. 11 illustrates an example of a timing diagram 1100 showing a first resource 1115 for receiving at least one UL signal at a base station 1110, a second resource 1125 for transmitting a first UL signal by a first UE UE1 1120 and a third resource 1135 for transmitting a second UL signal by a second UE UE2 1130. A starting boundary of the first resource 1115 is indicated as a UL timing reference point for the base station. A starting boundary of the second resource 1125 is considered as the UL timing reference point 1127 for the first UE UE1 1120 and a starting boundary of the third resource 1135 is considered as the UL timing reference point 1137 for the second UE UE2 1130. The transmission time for a given UE may then be determined as the UL timing reference point 1117 for the base station minus the propagation delay between that UE and the base station. For example, for the second UE UE2 1130, the transmission time may be determined as the UL timing reference point 1117 minus the propagation delay between the second UE UE2 1130 and the base station 1100.

By taking the propagation delay between a UE and base station into account, alignment of the timing reference point between UE and BS is aligned.

Some embodiments of the disclosure provide a method involving determining an UL frame timing reference point at a terminal side device according to an UL timing reference point and a propagation delay between the terminal side device and the network side device, wherein determining the DL frame timing comprises determining a boundary of at least one of a frame, a slot, or a symbol.

From the perspective of the network side device, determining the UL frame timing involves determining, by the network side device, the UL timing reference point at the terminal side device based on the UL timing reference point at the network side device and the propagation delay. The method may also involve transmitting, by the network side device, an indication of the determined UL timing reference point at the terminal side device in a wireless communication device-specific signal.

In some embodiments, determining the UL frame timing involves transmitting, by the network side device, an indication of the UL timing reference point at the network side device in the form of a first absolute time value. The method also involves transmitting, by the network side device, a SSB in a frame that corresponds to a second absolute time value, which enables the terminal side device to determine the UL timing reference point at the terminal side device based on subtracting the determined propagation delay from the UL timing reference point at the network side device.

In some embodiments, the method further involves: receiving, by the network side device, signaling from the terminal side device at the UL timing reference point at the network side device.

In some embodiments, determining the UL frame timing involves: transmitting, by the network side device, a terminal side device-specific signal including an indication of the propagation delay from the network side device to the terminal side device, wherein the propagation delay is determined based on a transmission from the terminal side device and received at the network side device.

From the perspective of the UE, determining the UL frame timing involves receiving, by the terminal side device, a terminal side device-specific signal including an indication of the UL reference timing point at the wireless communication device which is a pre-compensated value of the UL reference timing point at the terminal side device based on the propagation delay from the network side device to the terminal side device and the UL timing reference point at the network side device.

In some embodiments, determining the UL frame timing involves receiving, by the terminal side device, an indication of the UL timing reference point at the network side device in the form of a first absolute time value. The method also involves detecting, by the terminal side device, a SSB in a frame that corresponds to a second absolute time value. The method may also include determining, by the wireless communication device, the propagation delay as a difference between the second and first absolute time values and determining, by the terminal side device, the UL timing reference point at the terminal side device based on subtracting the determined propagation delay from the UL timing reference point at the network side device.

In some embodiments, the method further involves transmitting, by the terminal side device, signaling to arrive at the UL timing reference point at the network side device.

In some embodiments, determining the UL frame timing involves receiving, by the terminal side device, a terminal side device-specific signal including an indication of the propagation delay from the network side device. The method may also include determining, by the terminal side device, the UL timing reference point at the terminal side device based on subtracting the determined propagation delay from the timing reference point at the network side device.

Sometimes during wireless communication a random access procedure is performed. Example situations in which a random access procedure may be performed include: initial network access and connection establishment for a terminal side device, e.g. registering with the network and acquiring uplink synchronization; re-synchronization when the terminal side device and base station are out of synchronization, which may occur when the terminal side device is in a connected state or in an inactive or idle state; connection re-establishment for connection failure; UL or DL data arrival when the uplink is in a non-synchronous condition; and/or handover procedure when timing synchronization is needed. When performing a random access procedure, a random access channel is used, e.g. a physical random access channel (PRACH).

The random access procedure often involves several steps. For example, a random access procedure may involve the following message exchanges: (1) the terminal side device transmits a preamble on configured random access channel resources; (2) in response to receipt of the preamble, the base station transmits a random access response (RAR) message; (3) in response to receipt of the RAR message, the terminal side device transmits an uplink transmission in an uplink data channel allocated by an uplink grant present in the RAR; and (4) in response to receipt of the uplink transmission from the terminal side device in the uplink data channel, the base station transmits a reply, which may include a contention resolution message. These message exchanges can occur sequentially in the order described or possibly the terminal side device could combine its messages and the base station could combine its messages.

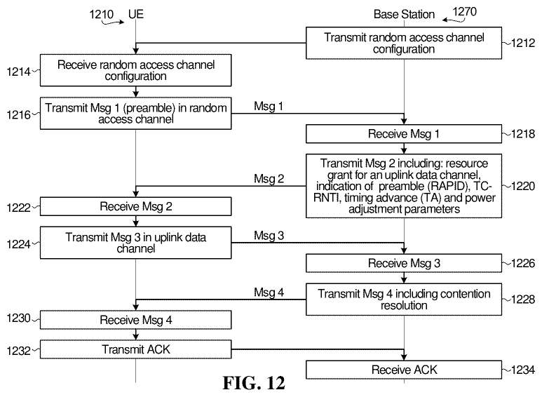

FIG. 12 is a flowchart illustrating steps of an example random access procedure according to a four-step random access procedure. The four-step procedure involves the exchange of four messages Msg 1, Msg 2, Msg 3, and Msg 4, as described below. Msg 1 and Msg 3 are transmitted by the terminal side device, such as a UE 1210, to a base station 1270, and Msg 2 and Msg 4 are transmitted as responses by the base station 1270 to UE 1210.

In step 1212, the base station 1270 transmits configuration information that configures the resources of a random access channel. The configuration information may be broadcast by base station 1270, e.g. as part of a synchronization signal block (SSB)/physical broadcast channel (PBCH). The configuration information may be carried in system information, e.g. remaining system information (RMSI)/other system information (OSI). In alternative embodiments, depending on the scenario, the configuration information may instead be transmitted in higher-layer signaling, such as in RRC signaling for a UE that is in an RRC connected state. In alternative embodiments, depending on the scenario, the configuration information may instead be transmitted in DCI.

In step 1214, UE 110 receives the random access channel configuration information that was transmitted by the base station 1270 in step 1212. When the configuration information is broadcast by the base station 1270, e.g. on a broadcast channel for initial network access, other UEs may also receive the configuration information.

The UE 1210 randomly selects a preamble, e.g. preamble index i, from the set of usable preambles indicated in the configuration information received in step 1214. In step 1216, the UE 1210 transmits the selected preamble on the random access channel to the base station 1270. The transmitted message carrying the preamble is referred to as Msg 1. In step 1218, Msg 1 is received by the base station 170.

The base station 1270 detects the preamble transmitted by the UE 1210, and in response the base station 1270 transmits a response, which is sometimes called a RAR. The response is transmitted in step 1220 on a downlink channel, e.g. on a downlink data channel, such as a PDSCH. The response is transmitted within a RAR time window, and the response corresponds to the preamble received in step 1218. The response includes information referred to as Msg 2.

In step 1222, the UE 1210 receives Msg 2. In step 1224, the UE 1210 sends an uplink data transmission in the uplink data channel using the resource grant present in Component 1 of Msg 2. The information sent in the uplink data transmission in step 1224 includes information referred to as Msg 3.

In step 1226, the base station 1270 receives Msg 3 in the uplink data channel. The data sent in Msg 3 is decoded. In step 1228, the base station 1270 transmits a response on a downlink channel, e.g. on a downlink data channel such as a PDSCH. The response carries information referred to as Msg 4.

In step 1230, UE 1210 receives the downlink transmission of Msg 4 and concludes that Msg 4 is for UE 1210 and that the random access procedure was successful because a valid contention resolution identity is decoded by UE 1210. In step 1232, UE 1210 transmits an acknowledgement (ACK) to the base station 1210 on an uplink channel, e.g. on an uplink control channel such as a physical uplink control channel (PUCCH). The ACK is received by the base station 1270 at step 1234.

In some embodiments, the UE 1210 retransmits Msg 1 with the same or different preamble if the transmission of Msg 2 is not received, or if the contention resolution identity in Msg 4 invalid. In some embodiments, the base station 1270 uses DCI to schedule UE 1210 to retransmit Msg 3 when no valid Msg 3 is detected by the base station 110 on the granted uplink data channel resource.

At a given time slot, one or more UEs may perform initial access and one or more UEs may perform data transmission after having initially accessed the network. Aspects of the present disclosure provide a method for enabling a UE to access a network successfully. Aspects of the present disclosure also enable a method for letting the UE know a type of frame timing that is used, i.e. timing reference point frame timing or non-timing reference point frame timing.

In some embodiments, there may be multiple types of frame timing. For example, the frame timing may be defined by a timing reference point. This type of frame timing may be called Type-1 Frame Timing or a Type-1 Frame Structure. The timing reference point (TimingRP for short) indicates a time at the starting or ending boundary of a frame. That is to say, the time location of a frame depends on the timing reference point location.

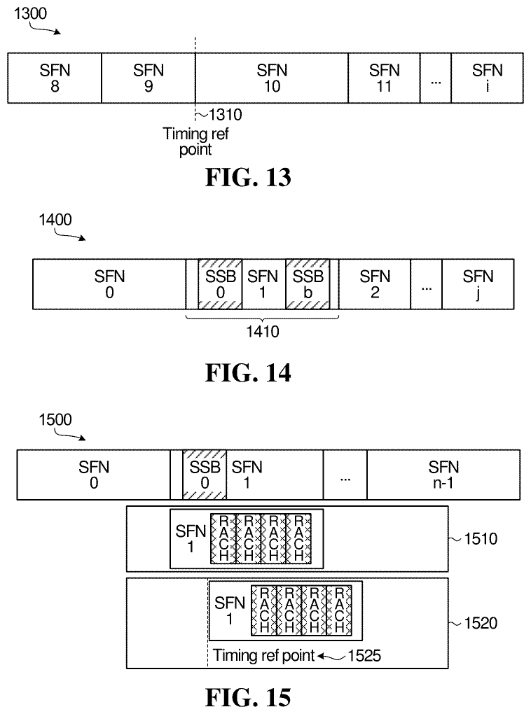

FIG. 13 shows an example of multiple frames 1300 each identified with a respective SFN. A timing reference point 1310 is shown at the start of a frame identified as SFN10. While the timing reference point 1310 is shown in FIG. 13, at the beginning of SFN10, it is understood that the timing reference point could be at the start or end of any frame.

In some embodiments, another type of frame timing is not defined by a timing reference point. This may be referred to as Type-2 Frame Timing or a Type-2 Frame Structure. In a particular embodiment, the frame included one or more SSB that can be used to determine frame timing. The SSB locations in the Type-2 Frame Timing are pre-defined. An example of how SSB locations may be pre-defined is described in section 4.1 in 3GPP TS 38.213 V17.2.0.

A synchronization signal (SS) block includes a time index that explicitly provides a relative location of the SS block within multiple possible SS block locations. Therefore, by detecting the SS block, the UE may determine the Type-2 frame timing, i.e. the frame boundary.

FIG. 14 shows an example of multiple frames 1400 each identified with a respective SFN. SFN1 is shown to include two SS blocks, SSB0 and SSBb. While only two SS blocks are shown in FIG. 14, it is understood that there may be more or less than two SS blocks in a given implementation.

The Type-2 Frame Timing may be used for SSB detection, COntrol REsource SET (CORESET0) time location determination, and SIB1 detection. Upon receipt of one or more frames, the UE attempts to detect the SSB. The UE may perform blind detection in order to detect the SSB. The UE may then continue to use the Type-2 Frame Timing according to detected SSB time location.

According to the Type-2 Frame Timing, the UE may determine the time location of CORESET0. CORESET0 is a set of time-frequency resources in which physical downlink control channel (PDCCH) may be transmitted. CORESET0 is a type of CORESET which carries PDCCH and Downlink control information (DCI) for SIB1. In some embodiments, according to a predefined rule to determine the slot index or symbol index for CORESET0, the UE may obtain the slot index or symbol index in the Type-2 Frame Timing for CORESET0.

After obtaining the DCI for SIB1 in the CORESET0, the UE may obtain scheduling information for SIB1. For time-domain scheduling information, the UE may assume information, such as a slot offset for SIB1 or a symbol location for SIB1, is based on the Type-2 Frame Timing.

In some embodiments, SIB1 indicates timing reference point information. In some embodiments, after the UE obtains the timing reference point information, the UE may transition from using the Type-2 Frame Timing to using the Type-1 Frame Timing.

In some embodiments, the timing reference point information may indicate the reference SFN in Type-2 Frame Timing plus a time offset from a reference SFN.

In some embodiments, the timing reference point information may indicate a reference SFN in Type-2 Frame Timing. The reference SFN maybe pre-defined as the SFN where the SIB1 that indicates the timing reference point is located. The SIB1 may indicate a time offset from the reference SFN.

In some embodiments, the timing reference point information may indicate the absolute timing value (e.g. GPS time) for the timing reference point.

### Msg-1:

Referring back to the initial access method shown in FIG. 12, prior to the UE 1210 transmitting Msg 1 at step 1216, the UE 1210 detects the SSB and obtains SIB1. The UE 1210 also determines one or more RACH Occasion (RO) during which to send a RACH preamble. Step 1214 of FIG. 12 indicates the UE 1210 receives RA channel configuration information. This configuration information may include RO configuration information. The RO configuration information includes information that the base station 1270 has configured time locations that are available for the reception of a RACH preamble at the base station. The configured time locations may include a system frame number or a slot index or a symbol index.

In some embodiments, the RO is determined by the UE based on the UE using Type-2 Frame Timing. For example, the frame number or the slot index or the symbol index in the RO configuration may be numbered in reference to Type-2 Frame Timing.

In some embodiments, the RO is determined by the UE based on the UE using Type-1 Frame Timing. For example, the frame number or the slot index or the symbol index in RO configuration may be numbered in reference to Type-1 Frame Timing.

FIG. 15 shows an example of multiple frames 1500 each identified with a respective SFN. SFN1 is shown to include SS block SSB0. When using the Type-2 Frame Timing 1510, the UE detects SSB0, and based on the configuration information from the base station about possible RACH Occasions, the UE may select a RACH to send the preamble.

When using the Type-1 Frame Timing 1520, the UE detects SSB0 and is able to obtain a timing reference point 1525 from the COREST0. Based on the timing reference point and the configuration information from the base station about possible RACH Occasions, the UE may select a RACH to send the preamble with reference to the timing reference point.

### Msg-2:

Referring back to the initial access method shown in FIG. 12, after the base station 1270 receives the Msg1 sent by the UE 1210 at step 1218, the base station 1270 will send Random Access Response (RAR) to the UE 1210. In some embodiments, the UE 1210 may use a random access radio network temporary identifier (RA-RNTI) to blind decode the DCI for RAR. In some embodiments, the RA-RNTI depends on a at least one of a slot index or a symbol index of the PRACH transmission by the UE 1210.

In current versions of the 5G specification, the RA-RNTI may be determined based on the following relationship:

RA-RNTI=1+s_{id}+14×t_{id}+14×80×f_{id}+14×80×8×U_{carrier id}+14×80×8×8×UL_{carrier id}
where:
   s_{id}: the index of the first OFDM symbol of the specified PRACH (0<=s_id<14), specified PRACH is the PRACH transmitted by the UE;
   t_{id}: the index of the first slot symbol of the specified PRACH in a system frame (0<=t_id<80);
   f_{id}: the index of the specified PRACH in the frequency domain (0<=s_id<8); and
   UL_{carrier id}: UL carrier used for Msg1 transmission (0=normal carrier, 1=SUL carrier).

The slot index or symbol index in the RA-RNTI calculation may be based on either of Type-2 Frame Timing or Type-1 Frame Timing.

When the RA-RNTI is determined based on Type-2 Frame Timing, at least one of the slot index or the symbol index is numbered with regard to Type-2 Frame Timing. For example, slots are numbered in increasing order within a frame in Type-2 Frame Timing.

When the RA-RNTI is determined based on Type-1 Frame Timing, at least one of the slot index or the symbol index is numbered with regard to Type-1 Frame Timing.

In some embodiments, the RAR includes the UL Timing Reference Point. In some embodiments, the UL Timing Reference Point may be expressed in the from of a reference point (e.g. DL timing reference point, or a reference SFN) plus a timing offset. In some embodiments, the UL Timing Reference Point may be expressed in the from of an absolute time value.

It is noted that no Timing Advance (TA) value is included in the RAR when using on Type-2 Frame Timing or Type-1 Frame Timing.

With regard to transmitting and receiving Msg 3, for example steps 1224, and 1226 in FIG. 12, Msg 3 transmission may occur based on the Type-1 Frame Timing or Type-2 Frame Timing.

With regard to transmitting and receiving Msg 4, for example steps 1228, and 1230 in FIG. 12, Msg 4 transmission may occur based on the Type-1 Frame Timing or Type-2 Frame Timing.

In some embodiments, for Msg 3 and Msg 4 transmission, the DL and UL timing reference points may be known at the UE side and therefore transmissions may be based on Type-1 Frame Timing.

In some embodiments, as opposed to using only Type-2 Frame Timing or a combination of Type-2 Frame Timing and Type-1 Frame Timing, only Type-1 Frame Timing, which is timing reference point frame timing, is used.

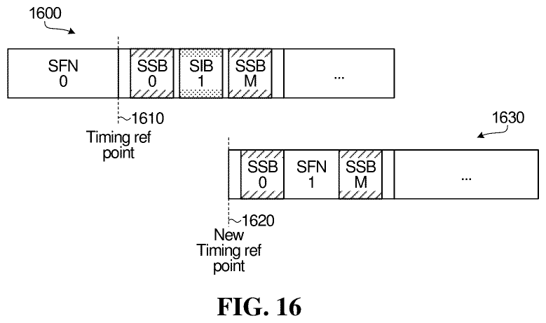

FIG. 16 shows an example of multiple frames 1600 each identified with a respective SFN. SFN1, starting at a first timing reference point 1610 is shown to include SS blocks SSB0 and SSB M. SIB1 information is located between SBB0 and SSB M. The UE may detect the SIB1 information and determine the timing reference point enabling the use of Type-1 Frame Timing. However, when the timing reference point is changed to be a new timing reference point 1620, the frame timing is updated accordingly, and signals and channels follow the new frame timing 1630, include SSB, CORESET0, SIB1. However, as the UE has not initial access the network, the UE may not know the timing reference point has been updated.

During UE initial access, a UE attempts to decode a SS block in one or multiple SS burst set. A set of SS blocks within a beam-sweep may be referred to as an SS burst set. Candidate time locations of SS blocks are pre-defined according to frame timing.

After timing reference point 1610 had been updated to the timing reference point 1620, the candidate time locations of SSB blocks are changed accordingly based on the updated timing reference point 1620. However, the UE likely does not know that the frame timing has been updated because the UE has not received the current SIB1, and the UE is attempting to decode the SS block according to the previously known timing reference point 1610.

In some embodiments, when the UE does not successfully receive SSB in one or multiple SS burst sets because the UE expects the synchronization signal block (SSB) to be in a particular location, the UE may start to blind detect the SSB from a particular point in time and drop previously received SSB. The UE may not successfully receive SSB in one or multiple SS burst sets during a pre-defined duration that is determined by the expiry of a timer.

In some embodiments, the UE may attempt to detect the SSB in all time slots (e.g. all symbols). In this manner, the UE may determine that the timing reference point has changed. For example, then the UE detects the SSB, the UE is able to obtain the DCI for SIB1 in the CORESET0, the UE may then obtain scheduling information for SIB1 and as a result obtain the timing reference point information from SIB1.

Some aspects of the disclosure provide a solution to a problem of how to receive SSB, PDCCH in CORESET0, and SIB1 before a UE may receive a timing reference point indication.

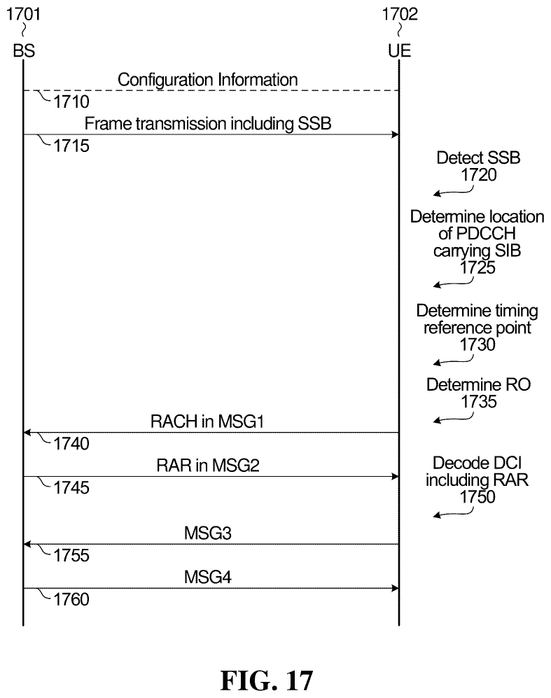

FIG. 17 illustrates a signal flow diagram for signalling between a base station and a UE illustrating an example process for supporting network communication, in accordance with embodiments of the present disclosure.

The example process 1700 is comprised of steps 1710, 1715, 1720, 1725, 1730, 1735, 1740, 1745, 1750, 1755 and 1760. Some of the steps may be optional. It should be understood that, in some embodiments, the order of one or more steps 1710, 1715, 1720, 1725, 1730, 1735, 1740, 1745, 1750, 1755 and 1760 may be changed.

At step 1710, a BS 1701 may optionally transmit configuration information that includes RACH occasion (RO) configuration information indicating locations available for transmission of a RACH preamble to a network side device.

At step 1715, the BS 1701 transmits at least one SSB in a frame and the UE 1702 receives the at least one SSB in the frame.

At step 1720, the UE 1702 detects the at least one SSB received in step 1715.

At step 1725, the UE 1702 determines a location of a physical resource including a physical downlink control channel (PDCCH) carrying system information block (SIB) control information.

At step 1730, the UE 1702 determines a timing reference point from a SIB that is located using the SIB control information. In some embodiments, frame timing is determined based on the detected SSB and the frame timing is used for SSB CORESET0 time location determination and system information block 1 (SIB1) detection.

In some embodiments, the UE 1702 may determine a second frame timing based on the timing reference point, wherein the second frame timing is used for physical channel transmission.

At step 1735, the UE 1702 determines a RO for transmitting the RACH preamble based on the RO configuration information. The determining the RO is performed based on: a system frame number (SFN) or a slot index or a symbol index with reference to frame timing based on the received SSB; or a SFN or a slot index or a symbol index with reference to frame timing based on the timing reference point.

At step 1740, the UE 1702 transmits the RACH on the determined RO. In some embodiments, transmitting the RACH preamble comprises transmitting the RACH preamble in a message 1 (MSG1) transmission on the determined RO.

In some embodiments, the timing reference point is expressed in the form of at least one of: a) a reference SFN plus an offset to the timing reference point; b) an offset to the timing reference point, the offset with reference to a reference system frame that is pre-defined to be a SFN where SIB that comprises the timing reference point is located; or c) an absolute timing value.

At step 1745, the UE 1702 receives a random access response (RAR) in a message 2 (MSG2) transmission.

At step 1750, the UE 1702 decodes DCI including the RAR using a random access radio network temporary identifier (RA-RNTI) based on at least one of a slot index or a symbol index associated with the transmitted RACH preamble. In some embodiments, the RA-RNTI based on at least one of the slot index or symbol index of the RACH preamble transmission is one of: a slot index or symbol index with reference to the frame timing based on the received SSB; or a slot index or symbol index with reference to the frame timing based on the timing reference point.

At step 1755, the UE 1702 sends a message 3 (MSG3) transmission based on: a SFN or slot index or symbol index with reference to the frame timing based on the received SSB; or a SFN or slot index or symbol index with reference to the frame timing based on the timing reference point.

At step 1760, the UE 1702 receives a message 4 (MSG4) transmission based on: a SFN or slot index or symbol index with reference to the frame timing based on the received SSB; or a SFN or slot index or symbol index with reference to the frame timing based on the timing reference point.

In some embodiments, the UE 1702 receives information indicative of a SFN of a starting frame in a frame structure, wherein a starting boundary of the starting frame is aligned with the timing reference point.

In some embodiments, a SFN of a starting frame in frame structure is determined according to a predetermined rule, wherein a starting boundary of the starting frame is aligned with the timing reference point. In some embodiments, the predetermined rule: indicates that the SFN of the starting frame is to be updated based on the timing reference point; indicates that the starting frame is SFN0 in a frame structure updated based on the timing reference point; or indicates that the SFN of the starting frame is determined based on a starting frame of a frame structure having a different timing reference point, wherein the starting boundary of the frame structure is aligned with the different timing reference point.

In some embodiments, when at least one SSB is not successfully received during a predefined duration, the detecting of the at least one SSB is performed for additional SSB.

The embodiments described above are in the context of UEs communicating with a BS. However, more generally, devices that wirelessly communicate with each other over time-frequency resources need not necessarily be one or more UEs communicating with a BS. For example, two or more UEs may wirelessly communicate with each other over a sidelink using device-to-device (D2D) communication. As another example, two network devices (e.g., a terrestrial base station and a non-terrestrial base station, such as a drone) may wirelessly communicate with each other over a backhaul link. Embodiments are not limited to uplink and/or downlink communication. For example, in the embodiments above, the BS may be substituted with another device, such as a node in the network or a UE. The uplink/downlink communication may instead be sidelink communication.

Examples of devices (e.g., UE, BS) to perform the various methods described herein are also disclosed.

For example, a device may include a memory to store processor-executable instructions, and a processor to execute the processor-executable instructions. When the processor executes the processor-executable instructions, the processor may be caused to perform the method steps of one or more of the devices as described herein, e.g., in relation to FIGS. 1 to 4 and 17. For example, the processor may cause the device to communicate over an air interface in a mode of operation by implementing operations consistent with that mode of operation, e.g. performing necessary measurements and generating content from those measurements, as configured for the mode of operation, preparing uplink transmissions and processing downlink transmissions, e.g. encoding, decoding, etc., and configuring and/or instructing transmission/reception on RF chain(s) and antenna(s).

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
detecting at least one synchronization signal block (SSB);
determining a location of a physical resource comprising a physical downlink control channel (PDCCH) carrying system information block (SIB) control information based on the at least one SSB; and
determining a timing reference point from a SIB that is located using the SIB control information.

2. The method of claim 1, wherein frame timing is determined based on the at least one SSB, and the frame timing is used for control resource set 0 (CORESET0) time location determination and system information block 1 (SIB1) detection.

3. The method of claim 1, further comprising determining a second frame timing based on the timing reference point, wherein the second frame timing is used for physical channel transmission.

4. The method of claim 1, wherein the timing reference point is expressed in the form of at least one of:
a reference system frame number (SFN) plus an offset to the timing reference point; an offset to the timing reference point, the offset being with reference to a reference system frame that is pre-defined to be a SFN where an SIB that comprises the timing reference point is located; or
an absolute timing value.

5. The method of claim 1, further comprising receiving random access channel (RACH) occasion (RO) configuration information indicating locations available for transmission of a RACH preamble to a network side device.

6. The method of claim 5, further comprising determining a RO for transmitting the RACH preamble based on the RO configuration information, wherein determining the RO is performed based on:
a system frame number (SFN) or a slot index or a symbol index with reference to frame timing based on the received SSB; or
a SFN or a slot index or a symbol index with reference to frame timing based on the timing reference point.

7. An apparatus comprising:
one or more processors coupled with a non-transitory processor readable medium storing instructions, wherein when the instruction executed by the one or more processors, the apparatus is caused to:
detect at least one synchronization signal block (SSB);
determine a location of a physical resource comprising a physical downlink control channel (PDCCH) carrying system information block (SIB) control information based on the at least one SSB; and
determining a timing reference point from a SIB that is located using the SIB control information.

8. The apparatus of claim 7, wherein frame timing is determined based on the at least one SSB, and the frame timing is used for control resource set 0 (CORESET0) time location determination and system information block 1 (SIB1) detection.

9. The apparatus of claim 7, wherein the apparatus is further caused to:
determine a second frame timing based on the timing reference point, wherein the second frame timing is used for physical channel transmission.

10. The apparatus of claim 7, wherein the timing reference point is expressed in the form of at least one of:
a reference system frame number (SFN) plus an offset to the timing reference point;
an offset to the timing reference point, the offset with reference to a reference system frame that is pre-defined to be a SFN where an SIB that comprises the timing reference point is located; or
an absolute timing value.

11. The apparatus of claim 7, wherein the apparatus is further caused to:
receive random access channel (RACH) occasion (RO) configuration information indicating locations available for transmission of a RACH preamble to a network side device.

12. The apparatus of claim 11, wherein the apparatus is further caused to:
determine a RO for transmitting the RACH preamble based on the RO configuration information, wherein determining the RO is performed based on:
a system frame number (SFN) or a slot index or a symbol index with reference to frame timing based on the received SSB; or
a SFN or a slot index or a symbol index with reference to frame timing based on the timing reference point.

13. The apparatus of claim 7, wherein a SFN of a starting frame in a frame structure is determined according to a predetermined rule, and wherein a starting boundary of the starting frame is aligned with the timing reference point.

14. An apparatus comprising:
one or more processors coupled with a non-transitory processor readable medium storing instructions, wherein when the instruction executed by the one or more processors, the apparatus is caused to:
transmit at least one synchronization signal block (SSB) in a frame, the at least one SSB being used by a wireless device to determine a location of physical resource comprising a physical downlink control channel (PDCCH) carrying system information block (SIB) control information, and the SIB control information being to locate an SIB by the wireless device in order to determine a timing reference point.

15. The apparatus of claim 14, wherein frame timing is determined based on the at least one SSB, and the frame timing is used for control resource set 0 (CORESET0) time location determination and system information block 1 (SIB1) detection.

16. The apparatus of claim 14, wherein a second frame timing is based on the timing reference point, and wherein the second frame timing is used for physical channel transmission.

17. The apparatus of claim 14, wherein the timing reference point is expressed in the form of at least one of:
a reference system frame number (SFN) plus an offset to the timing reference point;
an offset to the timing reference point, the offset being with reference to a reference system frame that is pre-defined to be a SFN where an SIB that comprises the timing reference point is located; or
an absolute timing value.

18. The apparatus of claim 14, wherein the apparatus is further caused to:
transmit random access channel (RACH) occasion (RO) configuration information indicating locations available for transmission of a RACH preamble by the wireless device.

19. The apparatus of claim 18, wherein the apparatus is further caused to:
determine a RO for transmitting the RACH preamble based on the RO configuration information, wherein the RO is based on:
a system frame number (SFN) or a slot index or a symbol index with reference to frame timing based on the SSB; or
a SFN or a slot index or a symbol index with reference to frame timing based on the timing reference point.

20. The apparatus of claim 14, wherein a SFN of a starting frame in a frame structure is determined according to a predetermined rule, wherein a starting boundary of the starting frame is aligned with the timing reference point.
